(19) United States
(12) Patent Application Publication
(10) Pub. No.: US 2012/0034897 A1
(43) Pub. Date: Feb. 9, 2012

(54) REAL TIME TEXT MESSAGING METHOD AND DEVICE

(75) Inventors: Stuart Kreitzer, Coral Springs, FL (US); William Alberth, Prairie Grove, IL (US); Wayne Ballantyne, Coconut Creek, FL (US)

(73) Assignee: MOTOROLA, INC., Schaumburg, IL (US)

(21) Appl. No.: 12/850,450

(22) Filed: Aug. 4, 2010

Related U.S. Application Data
(63) Continuation of application No. 12/850,385, filed on Aug. 4, 2010.

(51) Int. Cl. H04W 4/22; H04W 24/00; H04M 11/04; H04W 4/12

(52) U.S. Cl. 455/404.1; 455/466; 455/457

(57) ABSTRACT

Embodiments include communication devices and texting methods performed by communication devices. When the communication device detects that a text session has been initiated with a potential real time text (RTT) destination specified as a destination for text messages transmitted by the communication device, the communication device automatically transitions into an RTT transmission mode. While in the RTT transmission mode, text messages may be communicated to the destination using an RTT protocol. A response system may be configured to communicate with the communication device, while the communication device is in the RTT transmission mode.

### CROSS-REFERENCE TO RELATED APPLICATION

This application is a continuation of prior-filed nonprovisional application Ser. No. 12/850,385.

### TECHNICAL FIELD

Embodiments of the present invention generally relate to text messaging between communication devices.

### BACKGROUND

Text messaging applications implemented on communication devices provide device users with a way to communicate with each other in an efficient and convenient manner. In addition, text messaging allows device users who cannot or do not wish to communicate verbally to communicate nonetheless. Due to the prevalence of text messaging applications on relatively inexpensive and commonly available communication devices (e.g., cellular telephones, computers, and so on), device users are trending away from using older systems that were adapted to provide for nonverbal, device-to-device communications. For example, hearing impaired individuals previously may have used TDD (Telecommunications Device for the Deaf) or TTY (Telephone TYpewriter) terminals to communicate over telephone networks. A typical TDD terminal includes an integrated keyboard, display, and acoustic coupler (e.g., including a modem). A telephone is inserted into the acoustic coupler to provide a communications connection over a voice traffic channel of a telephone network (e.g., a Public Switched Telephone Network). A TDD terminal may implement any of a number of textphone standards (e.g., Baudot code, V.18, V.21, V.23, EDT, DTMF (Dual-Tone Multi-Frequency signaling)) to facilitate terminal-to-terminal communications.

Besides being used for everyday communications, hearing impaired individuals also have relied on TDD terminals to communicate with emergency response centers (e.g., 911 dispatchers) in times of emergency. When the individual is at a location where a TDD terminal is readily available, the TDD terminal may provide for adequate communication in an emergency situation, leading to a rapid response and assistance to the individual. However, when the user is at a location in which a TDD terminal is not readily available, it may be more difficult for the individual to obtain emergency assistance.

Many hearing impaired individuals have turned to texting applications implemented on cellular telephones and computers as an alternative to communicating using TDD terminals. However, text-based communications with emergency response centers has not yet been widely implemented. In addition, the nature of current texting applications does not lend itself well to a rapid exchange of information between an individual and a dispatcher in an emergency situation. Thus, use of the current texting applications may result in less-than-optimal emergency responses.

Accordingly, current text-based communications technologies would benefit from improvements that may facilitate improved communications between individuals with common communication devices and a server-based enterprise, such as an emergency response center. Such improved communications may benefit not only hearing impaired individuals and operators at an emergency response center, but also any other individual who desires to communicate with an emergency response center using text-based communications, rather than voice communications (e.g., the victim of a robbery, a choking victim, or an individual in another situation in which voice communications is dangerous, difficult or impossible).

### BRIEF DESCRIPTION OF THE DRAWINGS

The present invention will hereinafter be described in conjunction with the following drawing figures, wherein like numerals denote like elements, and

FIG. 1 is a simplified block diagram of a communication system that includes a response center and a text-enabled communication device, in accordance with an embodiment;

FIG. 2 is a flowchart of a method for a communication device to initiate and execute a real time text session, in accordance with an example embodiment;

FIG. 3 is a flowchart of a method for a communication device to transmit user input information while the communication device is in a real time text mode, in accordance with an example embodiment;

FIG. 4 is a flowchart of a method for an emergency response center to execute a real time text session, in accordance with an example embodiment; and

FIGS. 5-8 illustrate an example of a series of communication device and emergency response center display screens, in accordance with an example embodiment.

### DETAILED DESCRIPTION

Embodiments include methods and apparatus for facilitating text communication between a first communication device (e.g., a cellular telephone) and a second communication device (e.g., communications and user interface equipment associated with an emergency response center). An embodiment of a method performed by the first communication device comprises the steps of detecting that a text session has been initiated by the first communication device with a potential real time text (RTT) destination (e.g., an emergency response center) specified as a destination for text messages transmitted by the first communication device in the context of the text session. In response to the detecting step, the first communication device automatically transitions itself into an RTT transmission mode. Essentially, while the first communication device is in the RTT transmission mode, the first communication device transmits indications of user inputs according to an RTT process and protocol, as will be described in more detail below.

An embodiment of a method performed by the second communication device (e.g., the communications and user interface equipment associated with the emergency response center) comprises the steps of establishing a text session over a communication network with the first communication device, determining that the first communication device is RTT enabled, and automatically transitioning the second communication device into an RTT reception mode. While the second communication device is in the RTT reception mode, the second communication device receives indications of user inputs and presents the user inputs to a user of the second communication device according to the RTT process and protocol.

Communications using an RTT protocol is distinguishable from communications using a standard texting protocol. When a communication device is in a standard operational mode in which a text session is governed by a standard texting protocol, characters entered into the user interface are buffered in the device, and the buffered characters are not transmitted by the device until the user provides a “SEND” command (e.g., via an icon selection, key click, or option selection from a drop-down menu). For example, a standard texting protocol used in accordance with an embodiment may include, but is not limited to, a texting protocol selected from a group consisting of a Multimedia Messaging Service (MMS) protocol, a Short Message Service (SMS) protocol, or a Session Initiation Protocol for Instant Messaging and Presence Leveraging Extensions (SIMPLE) protocol. In contrast, from the perspective of the first communication device, communications performed using an RTT protocol includes transmitting indications of characters (or editing inputs) entered into the user interface as the user inputs are entered and regardless of whether a “SEND” command has been received through the user interface, according to an embodiment. The RTT protocol may include, for example but not by way of limitation, Text over IP (ToIP) or other protocols (e.g., TCP/IP).

In various embodiments, indications of single user inputs (e.g., a single character or editing input) or small groups of user inputs (e.g., small groups of characters and/or editing inputs) are transmitted by the first communication device within a fraction of a second (e.g., 300 milliseconds (ms) or less) of entry via the user interface. In alternate embodiments, indications of single user inputs or groups of user inputs may be transmitted within a longer period. For example, the RTT transmission mode may include transmitting an indication of each user keystroke over the network on a keystroke-by-keystroke basis (e.g., a distinct data packet (e.g., an IP packet) is transmitted conveying each keystroke). In alternate embodiments, the RTT transmission mode may include transmitting indications of a plurality of keystrokes (e.g., corresponding to a word, phrase, sentence, and any editing inputs provided while typing the word, phrase or sentence), regardless of whether a “SEND” command has been received. As used herein, a “user input” may include manipulation of a user interface to select an alphanumeric character and manipulation of the user interface to indicate an editing input (e.g., a backspace selection, a deletion of one or more characters, a character selection, and so on), where the alphanumeric characters and editing inputs (or control characters) may be encoded using a standard or non-standard character encoding scheme (e.g., a character defined in the ASCII character encoding scheme, Unicode, the ISO/IEC 10646 Universal Character Set, or other schemes).

From the perspective of the second communication device (e.g., communications and user interface equipment associated with an emergency response center), communications performed using an RTT protocol includes receiving indications of a single character (or editing input) or a small groups of characters (or editing inputs), then concatenating and displaying the characters or groups of characters together as they are received, thus representing a cohesive message. Despite the fact that the second communication device may receive a number of data packets in the context of a single text message (e.g., each data packet may includes a single character or a relatively small number of characters), the second communication device does not indicate the end of the text message until the second communication device receives a “SEND” command, in an embodiment. According to an embodiment, although the second communication device receives and processes information from the first communication device according to an RTT process and protocol, the second communication device does not transmit information to the first communication device using an RTT process and protocol. Instead, the second communication device transmits information to the first communication device using a standard text protocol, in an embodiment. In an alternate embodiment, the second communication device may transmit information to the first communication device using an RTT process and protocol.

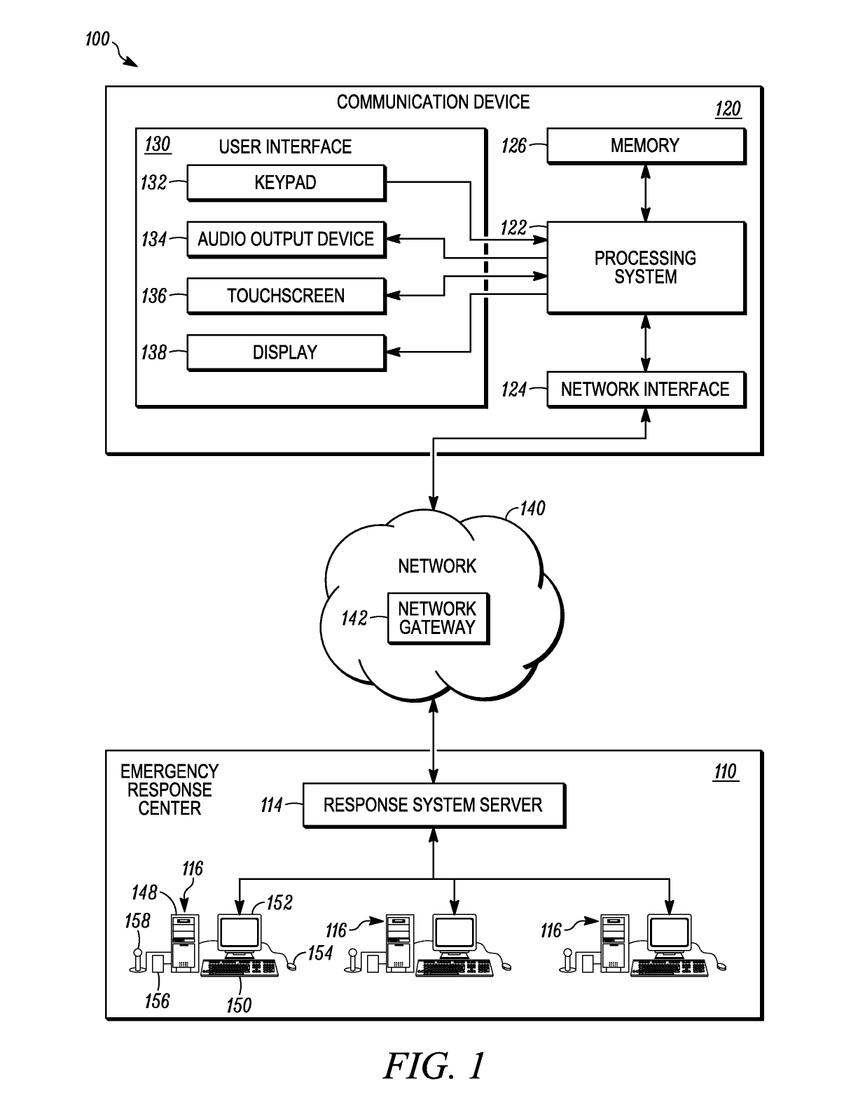

FIG. 1 is a simplified block diagram of a communication system 100 that includes an emergency response center 110 and a text-enabled communication device 120, in accordance with an embodiment. Emergency response center 110 and communication device 120 may communicate with each other over a network 140, which may include any one or more of a cellular telephone network, a terrestrial telephone network (e.g., a Public Switched Telephone Network (PSTN)), a data communication network (e.g., the Internet, a local area network, a wide area network, and so on), and/or other communications systems and subsystems that facilitate data exchange between emergency response center 110 and communication device 120. Network 140 may include a network gateway 142, in an embodiment, which is configured to perform conversions of received messages and signals between various networks. In another embodiment, network gateway 142 also may be configured to transcode between different forms of text transport methods (e.g., between ToIP in IP networks and Baudot or ITU-T V.21 text telephony in a PSTN).

Network 140 may be a wireless network, a wired network, or a combination of wired and wireless networks. When network 140 is a wireless network, both emergency response center 110 and communication device 120 may connect to network 140 wirelessly. Similarly, when network 140 is a wired network, both emergency response center 110 and communication device 120 may connect to network 140 via wired connections. Alternatively, when network 140 is a combination of wired and wireless networks, at least one of emergency response center 110 and communication device 120 may connect to network 140 wirelessly, and emergency response center 110 and communication device 120 may connect to network 140 via a wired connection.

Communication device 120 may be, for example but not by way of limitation, a cellular telephone, a conventional landline telephone, a radio, a personal data assistant, a pager, a computer (e.g., a laptop, desktop, notebook, or other computer), a vehicle-based communications device, a TDD (Telecommunications Device for the Deaf) terminal, a TTY (Telephone TYpewriter) terminal or another network-enabled communication and/or computing device. Communication device 120 includes a processing system 122, which is coupled to one or more network interfaces 124, memory 126, and user interface circuitry 130.

Processing system 122 provides information to network interface 124 for transmission over network 140 to emergency response center 110. As will be described in more detail below, this information includes indications of user inputs, which are communicated using an RTT communication protocol. In addition, processing system 122 receives information from network interface 124, which includes information transmitted by emergency response center 110 over network 140 to communication device 120. As will be described in more detail below, processing system 122 is configured automatically to enter an RTT transmission mode upon detecting that an emergency text session has been initiated (e.g., as a result of user inputs), when emergency response center 110 supports or requests it.

In an embodiment in which communication device 120 interfaces with a wireless network 140 (e.g., a cellular telephone or radio network), network interface 124 may include an antenna for receiving and transmitting radio frequency (RF) signals, receiver circuitry, transmitter circuitry, and circuitry to couple the antenna to the receiver circuitry and transmitter circuitry in a manner familiar to those skilled in the art. In an embodiment in which communication device 120 interfaces with a wired network 140, (e.g., a LAN, WAN, or other wired network), network interface 124 may include a network interface controller, network interface card or network adapter (e.g., a LAN or WAN adapter).

Memory 126 is configured to store information received from processing system 122 and to provide information to processing system 122. As will be described in more detail later, this information may include application software (e.g., text messaging application software), device state information (e.g., indicating whether the communication device 120 is in a regular operational mode or an RTT transmission mode), and information identifying potential RTT destinations (e.g., telephone numbers, uniform resource locators (URLs) or other information identifying emergency response centers or other entities). As will be described in more detail later, a potential RTT destination may include any entity (including emergency response center 110) associated with a destination identifier (e.g., a telephone number or URL) that causes communication device 120 to transition into an RTT transmission mode when a text message is addressed to that destination identifier. During a text communication session, processing system 122 may compare a destination identifier specified by the user with the information identifying potential RTT destinations stored in memory 126 to whether or not to transition the communication device 120 into the RTT transmission mode, as will be described in more detail later.

User interface circuitry 130 includes a plurality of devices adapted to receive information from a user of the communication device 120 and/or to convey information (e.g., visual, audible, or tangible information) to the user. User interface circuitry 130 may include, for example, a keypad 132, one or more audio output devices 134, and both or either a touchscreen 136 and/or a display device 138. In addition, user interface circuitry 130 may include various other devices (e.g., a microphone and/or haptic device (e.g., a vibrator)), not shown. Keypad 132 and touchscreen 136 are configured to receive typed inputs from a user of communication device 120, which inputs may include text, spaces, carriage returns, symbols, and control or text selection inputs (e.g., backspaces, deletions, text highlights, and so on). As will be described in more detail later, when communication device 120 is in an RTT transmission mode, indications of user inputs that are received by the processing system 122 from the keypad 132 and/or touchscreen 136 are transmitted via network interface 124 using an RTT communication protocol. This enables more comprehensive information regarding the actual user inputs to be conveyed to emergency response center 110.

Audio output device 134 may include one or more speakers for providing audio output to the user, which outputs may include speech, tones, clicks, ringtones, and other audible sounds. As will be described in more detail later, when communication device 120 is in an RTT transmission mode, one or more of the audio output devices 134 optionally may be disabled by processing system 122 (or processing system 122 simply does not provide control inputs or data to audio output devices 134, which would otherwise cause audio output devices 134 to produce audible sounds). By effectively silencing audio output devices 134, situations may be avoided in which an unintended individual (e.g., a perpetrator of a potential crime) is alerted to the texting activities of the user.

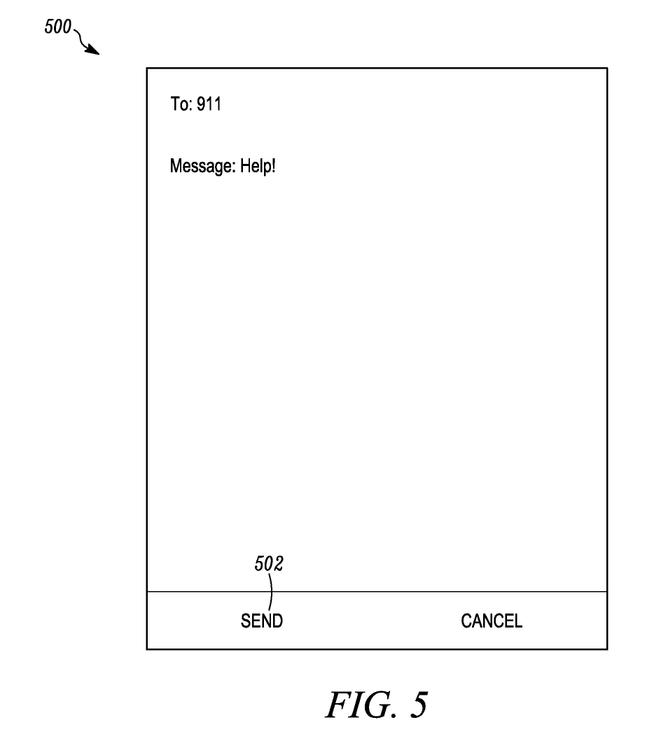

Display device 138 and/or touchscreen 136 are configured to present video output to a the user, such as text messages being generated by the user through manipulation of the keypad 132 and information conveyed from the emergency response center 110 to the communication device 120. Several non-limiting examples of screenshots that may be produced by display device 138 are illustrated in FIGS. 5-7, which will be described in more detail later.

Emergency response center 110 may be any entity, comprised of both computer and human resources, which is configured to receive communications from communication device 120 that are conveyed using RTT processes and protocols. For example, but not by way of limitation, emergency response center 110 may be a Public Safety Answering Point (PSAP, also known as a Public Safety Access Point), which is a call center responsible for answering calls from and supporting text communication sessions with network-connected communication devices (e.g., communication device 120) that have specified an emergency telephone number (e.g., 911) as a destination. Emergency response center 110 may, for example, be associated with a facility configured to receive information from users of various communication devices, to provide instructions to the users (via their communication devices), and to dispatch emergency responders (e.g., firefighters, paramedics, police officers, and so on), when appropriate. Although the invention is advantageous for communications with emergency centers, it will be recognized that the emergency response center may be any destination that is operable to at least receive communications using RTT processes and protocols. In addition, it is to be understood that all components of emergency response center 110 do not necessarily need to be co-located in a single facility. For example, in an embodiment, emergency response center 110 may be configured automatically to route indications of user inputs received from communication device 120 to a communication device operated by a respondent that is relatively close to the location of the communication device 120.

An embodiment of emergency response center 110, which may more generally be referred to as an “emergency response system” or “response system,” includes a server 114 and a plurality of response consoles 116. In an alternate embodiment, emergency response center 110 simply may include a network-enabled communication or computing device. Response consoles 116 typically are manned by human responders (not illustrated). Each response console 116 may include a processing system 148, a keyboard 150, display device 152, a cursor control device 154, and a headset (or a speaker 156 and microphone 158), operably coupled together, where elements 150, 152, 154, 156, and 158 comprise portions of a user interface of the response console 116. Display device 152 and speaker 156 may be considered more generally to be “response components,” and emergency response center 110 may include one or more additional or different response components, in various embodiments. Essentially, a response component is a system component that is configured to respond to received indications of user inputs, as will be described in more detail later. Other response components that may be included as part of the emergency response center 110 include, but are not limited to, an audio system configured to convert to speech the indications of the user inputs (e.g., for output on speaker 156), an automated data logging system (e.g., a logging system that is distinct from or integral with the response console 116), and/or an automated dispatch system responsive to the indications of the user inputs. Additionally, response components may be associated with equipment other than a response console 116. For example, as mentioned above, the emergency response center 110 may automatically route received indications of user inputs from communication device 120 to a communication device (not illustrated) operated by a respondent that is relatively close to the location of the communication device 120, and which is also remote from the emergency response center 110. In such a case, the communication device operated by the respondent may be considered as part of the emergency response center 110.

Each human responder may specifically be trained to evaluate information originating from a communication device 120 that is presented audibly (e.g., via speaker 156 or a headset) or visually (e.g., by display device 152), and to provide responsive spoken information (e.g., via microphone 158 or a headset), textual information (e.g., via manipulation of keyboard 150), and/or other visual information to be displayed on communication device 120 (e.g., drop-down menus, pop-up windows, option lists, images, video clips, video feeds, maps, and so on). Information displayed on a display device other than text may be referred to herein as a “display element.”

Response system server 114 is configured to communicate information originating from a response console 116 to communication device 120 via network 140, and also to communicate information received from communication device 120 via network 140 to the response console 116. When an initial communication is received from communication device 120 (e.g., a text session invitation), response system server 114 may determine a particular one of response consoles 116 that is available (e.g., a console that is not currently in a communication session with another remote device, and at which a human responder is available to provide assistance through interaction with the response console 116). In an embodiment, response system server 114 and the assigned response console 116 are configured to support RTT communications received from the communication device 120 in the context of an RTT session. More particularly, upon assigning a response console 116 to support an emergency text session with communication device 120, response system server 114 may receive RTT messages that include indications of user inputs into communication device 120, and response system server 114 may route the RTT messages and/or user input indications to the assigned response console 116. In addition, response system server 114 may receive messages from the assigned response console 116 (e.g., verbal messages, text messages, and/or other visual information), and convey those messages to the communication device 120 via network 140. Accordingly, response system server 114 facilitates communications between communication device 120 and a human responder at a particular response console 116.

In an embodiment, RTT messages are communicated from communication device 120 to emergency response center 110, but not vice versa. This one-way RTT communications protocol is to ensure that the human responder at a response console 116 receives as much information as possible regarding the actual user inputs to communication device 120, while providing only intended information from the human responder to the user of communication device 120 (e.g., thus avoiding transmitting confusing typographical errors or other unintended inputs from the response console 116 to the communication device 120). It is to be understood, however, that RTT messages are not precluded from being communicated from emergency response center 110 to communication device 120, in an alternate embodiment.

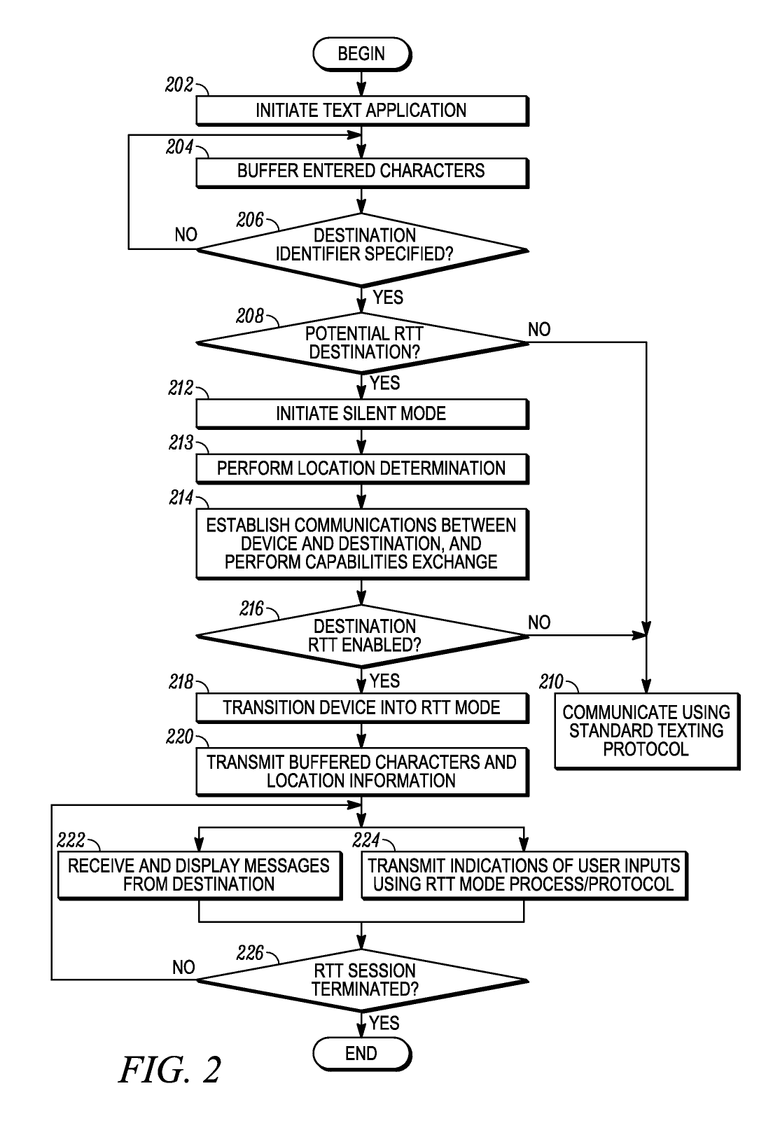

Although the term “emergency response center” is used herein and a PSAP is given as an example, it is to be understood that communication device 120 may conduct RTT sessions with other entities that do not have a specific purpose of responding to emergencies, according to various embodiments. Accordingly, usage of the term “emergency response center” throughout this description is not meant to limit the scope of the inventive subject matter. Emergency response center 110 may be considered in a broader sense to be a “potential RTT destination,” and the terms “potential RTT destination,” “RTT destination,” or simply “destination” may be substituted for the term “emergency response center” throughout this description. The term “potential RTT destination” means a destination of a text session (e.g., emergency response center 110) that is known (e.g., to the communication device 120) potentially to be RTT enabled. As will be described in more detail later, when a determination is made (e.g., in block 216, FIG. 2) that the potential RTT destination actually is RTT enabled, communication device 120 makes a transition to an RTT mode of operation, in accordance with an embodiment. According to the terminology used herein, once a determination is made that a potential RTT destination is RTT enabled, it may thereafter be referred to simply as an “RTT destination.”

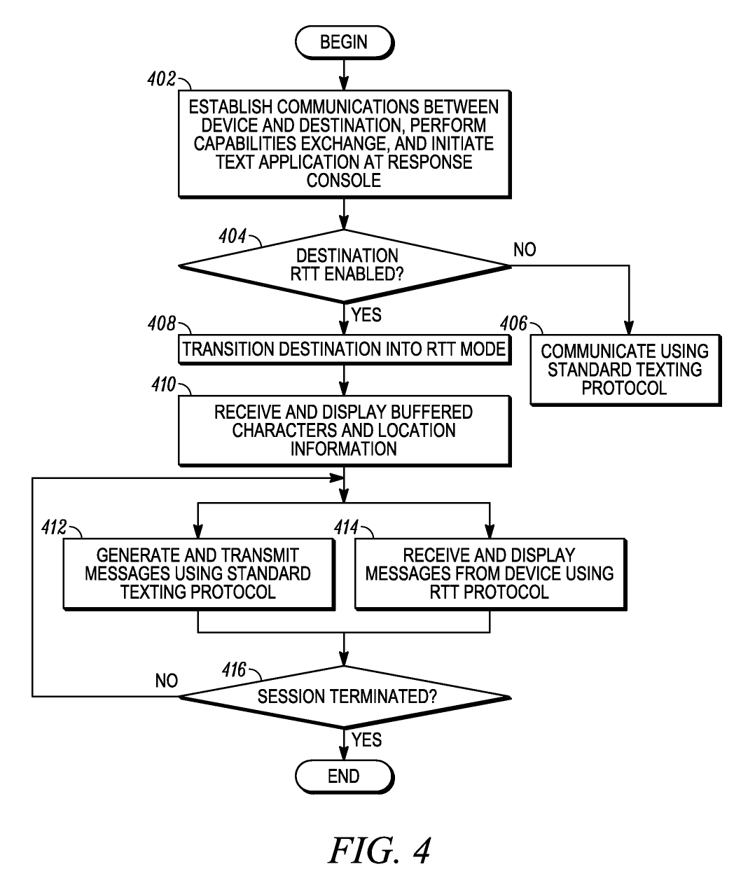

FIG. 2 is a flowchart of a method for a communication device to initiate and execute an RTT session, in accordance with an example embodiment. Although an RTT session involves the participation of both a communication device (e.g., communication device 120, FIG. 1) and a potential RTT destination (e.g., emergency response center 110, FIG. 1), according to an embodiment, the method of FIG. 2 includes steps performed by the communication device. More particularly, the method of FIG. 2 includes steps performed in conjunction with executing text messaging applications that are stored in memory (e.g., memory 126, FIG. 1) and executed by a processing system (e.g., processing system 122, FIG. 1) of the communication device. Method steps performed by the potential RTT destination will be described in more detail in conjunction with FIG. 4, later.

The method begins, in block 202, when a text messaging application is initiated on the communication device. The text messaging application is configured to support establishment of a text session, to cause a display device (e.g., display device 138, FIG. 1) of the communication device to provide a graphical user interface to facilitate the text session, to initiate transmission of text messages over a communication network from the communication device to a user-specified destination (i.e., other network-connected communication devices or systems, such as emergency response center 110, FIG. 1), and to receive and display text messages from other network-connected communication devices or systems. For example, a user may initiate a text application by selecting, via a user interface of the communication device, an option to send a text message (e.g., an MMS (Multimedia Messaging Service) message, an SMS (Short Message Service) message, or a SIP Instant Messaging protocol message, such as a SIMPLE (Session Initiation Protocol for Instant Messaging and Presence Leveraging Extensions) message).

Upon initiating a text application, the communication device may display (e.g., on display device 138, FIG. 1) a screen having a first area in which text messages from the communication device may be displayed, and a second area in which responder-entered characters and responder-selected display elements may be displayed (e.g., characters and display elements entered or selected by a human responder at a response console 116 of the emergency response center 110, FIG. 1). Alternatively, text messages from the communication device and responder-entered characters and responder-selected display elements may be displayed in an interleaved manner in an area of the display screen.

For example, FIG. 5 illustrates an example of a display screen 500 produced on a display device (e.g., display device 138, FIG. 1) of a communication device, in accordance with an example embodiment. Upon provision of the initial display screen, the user may type in characters and provide editing inputs through manipulation of the user interface (e.g., through manipulation of keypad 132 and/or touchscreen 136, FIG. 1). As the user types in the characters and provides the editing inputs, the communication device updates the screen on the display device with the entered information. An “editing input,” which may be represented by a control character, may include any of a backspace selection, a deletion of one or more characters, and a character selection (e.g., highlighting text), among other things. In the example display screen 500 of FIG. 5, the user has typed in the characters “HELP!”. Although the communication device indicates the user's editing inputs as the user is typing (e.g., by moving the displayed cursor, removing text, and so on), information indicating the user's editing inputs is not persistently indicated in the display screen 500.

According to an embodiment, prior to the user specifying a destination for the text message and providing a first “SEND” command, characters and editing inputs entered via the user interface are buffered, in block 204. This may include storing the entered characters and editing inputs in a memory device of the communication device (e.g., memory 126) or in one or more registers or data caches. For example, the characters “HELP!” may be buffered according to the example of FIG. 5. Because it may take a period of time for the communication device and the destination to establish a text session, characters and editing inputs may continue to be buffered during execution of blocks 206, 208, 212, 213, 214, 216, and 218 even after the first “SEND” command is provided, in an embodiment. Once the communication device has fully transitioned to the RTT transmission mode, character buffering may cease or it may be performed only in conjunction with storing a single character or editing input (or a small group of characters and/or editing inputs), just prior to transmission.

In block 206, a determination is made whether a destination identifier (e.g., a telephone number or address book name) for the text message has been specified. A destination identifier may be specified, for example, by the user typing in a telephone number (e.g., “911”) or indicating a stored contact in the communication device's contact database. Specification of the destination identifier may be consummated when the user provides a “SEND” command (e.g., the user selects the “SEND” icon 502, FIG. 5 through manipulation of the user interface). When the destination identifier for the text message has not been specified, the method continues to iterate as shown.

When a destination identifier for the text message has been specified, then in block 208, a further determination is made whether the destination identifier for the text message corresponds to a potential RTT destination, in an embodiment. As used herein, a potential RTT destination means any one or more network-connected destinations of electronic communications, for which it is predetermined that RTT communications is to be implemented when possible (e.g., when the potential RTT destination is RTT enabled, as will be determined in block 216). For example, a potential RTT destination may be an emergency response center (e.g., emergency response center 110, FIG. 1, which may be specified by the user entering “911” as illustrated in FIG. 5), in an embodiment, although a potential RTT destination may be a destination other than an emergency response center, in other embodiments. In an embodiment, identities of potential RTT destinations are known to the communication device in that the identities are stored (e.g., in memory 126, FIG. 1) in the communication device. In such an embodiment, the determination of whether the destination is a potential RTT destination involves comparing the destination identifier specified by the user with the potential RTT destination identities stored in the communication device. When the user-specified destination identifier matches a stored potential RTT destination identity, a determination is made that the destination is a potential RTT destination.

As discussed previously, the potential RTT destination may be an emergency response center. In such a case, the user likely intends the text session to be an “emergency text session.” As used herein, the term “emergency text session” means a text session carried out between a communication device and an emergency response center. Accordingly, execution of block 208 may be characterized also as detecting whether an emergency text session has been initiated (e.g., by the user initiating the text application and specifying an emergency response center as a destination). More specifically, detecting whether the emergency text session has been initiated includes determining that a text application has been initiated on the device with an indication of a potential RTT destination (e.g., an emergency response center) as a destination.

When the destination for the text message is not a potential RTT destination, then in block 210, the communication device and/or the text messaging application remain in a normal operational mode, and text communications is carried out using a standard texting protocol. However, when the destination for the text message is a potential RTT destination, then the process of performing an automatic transition into an RTT transmission mode is initiated. In an embodiment, transition of the communication device into the RTT transmission mode optionally includes the communication device transitioning into a “silent mode,” in block 212. Transitioning the device into the silent mode may include, for example, disabling one or more audio, vibrational, or other sound-producing outputs of the device (e.g., audio output device 134, FIG. 1) or controlling the communication device (e.g., processing system 122, FIG. 1) so as not to cause the sound-producing outputs actually to produce any sounds. Such a transition may result in a safer process of communicating an emergency incident. For example, in some cases, it may be desirable for the individual reporting the emergency incident to be as silent as possible so as not to alert a perpetrator to the individual's reporting activities. By transitioning the device into a silent mode (e.g., a mode in which all audio outputs, keyclicks, or other sounds produced by the device are quelled), the individual may report the incident without being detected by the perpetrator.

Transition of the communication device into an RTT transmission mode also may include performing a location determination process, in block 213. The location determination process may be carried out by a Global Positioning System (GPS) receiver system resident within the communication device, or using other well known, conventional location determination systems and technologies. The location determination process produces location information, which may thereafter be transmitted (e.g., in block 220) to the potential RTT destination to apprise a human responder as to the location of the communication device. Systems, technologies and methods for determining and transmitting location information are well known, and accordingly are not described in greater detail herein.

In block 214, communications are established between the communication device and the potential RTT destination over a network (e.g., network 140, FIG. 1), in order to initiate a text session between the two devices. Establishing the text session may include, for example, the communication device transmitting a session invitation message to the potential RTT destination, which indicates an identity of the communication device. The potential RTT destination may transmit an acknowledgement or other message back to the communication device, thus indicating that the potential RTT destination is available to support the text session.

A capabilities exchange process is then performed between the communication device and the potential RTT destination, in an embodiment, which includes the communication device receiving information from the potential RTT destination indicating whether or not the potential RTT destination (e.g., the Emergency Response Center 110, FIG. 1) is capable of communicating using an RTT process and protocol (e.g., whether the destination is “RTT enabled”). When a determination is made, in block 216, that the destination is not RTT enabled, then in block 210, the communication device and/or the text application remain in a normal operational mode, and text communications is carried out using a standard texting protocol, as described previously. More specifically, the process of automatically transitioning the device into RTT transmission mode, which will be described in more detail below, is bypassed when the destination is not RTT enabled.

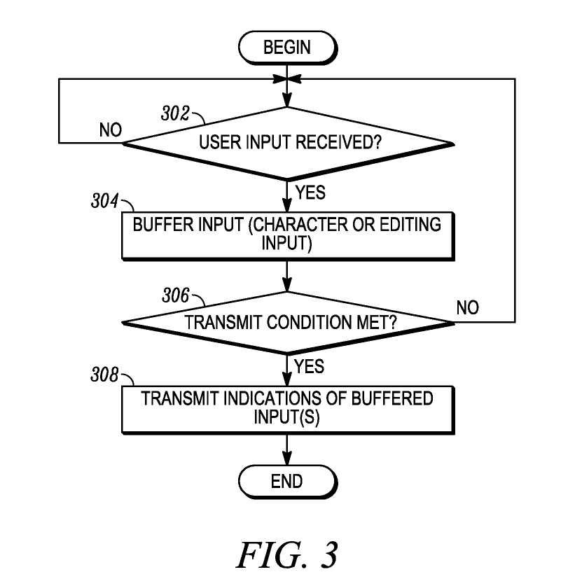

When a determination is made that the potential RTT destination is RTT enabled, then the communication device continues the transition into RTT transmission mode, in block 218. As discussed previously in conjunction with block 202, a text application initiated on the device is configured to carry out the various method steps discussed in conjunction with FIGS. 2 and 3. In an embodiment, the text application includes a first algorithm for controlling communications using a standard texting protocol and a second algorithm for controlling communications using an RTT protocol. In such an embodiment, transition into the RTT transmission mode includes branching execution of the text application to the second algorithm. In an alternate embodiment, the text application initiated on the device may not be configured to support communications in the RTT transmission mode, and instead the transition into the RTT transmission mode includes invoking a separate texting application (e.g., an RTT application) and stalling or terminating execution of the previously initiated text application.

In block 220, characters of the text message that were previously being buffered (e.g., in block 204 and during performance of blocks 206-218) are transmitted to the RTT destination. In addition, the optional location information (e.g., as determined in block 213), if included, is transmitted to the RTT destination.

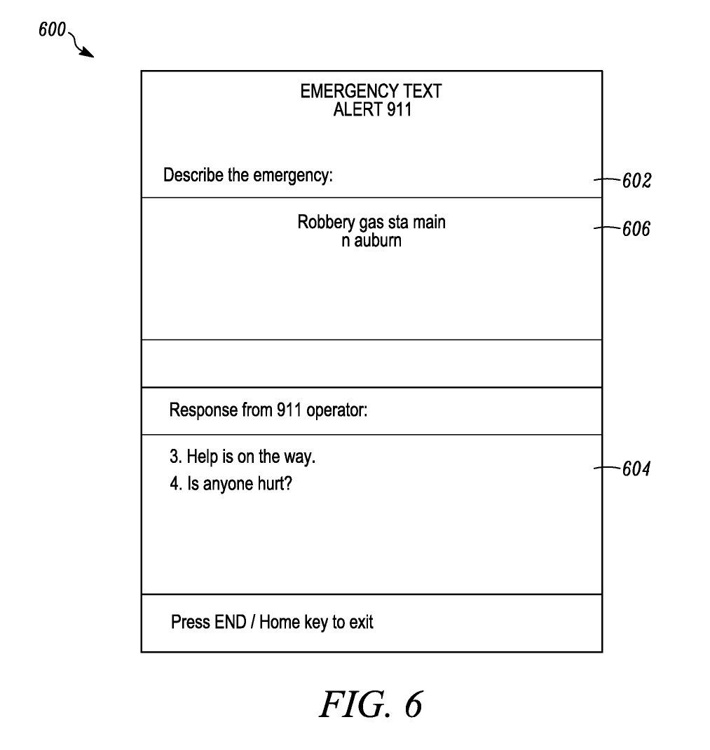

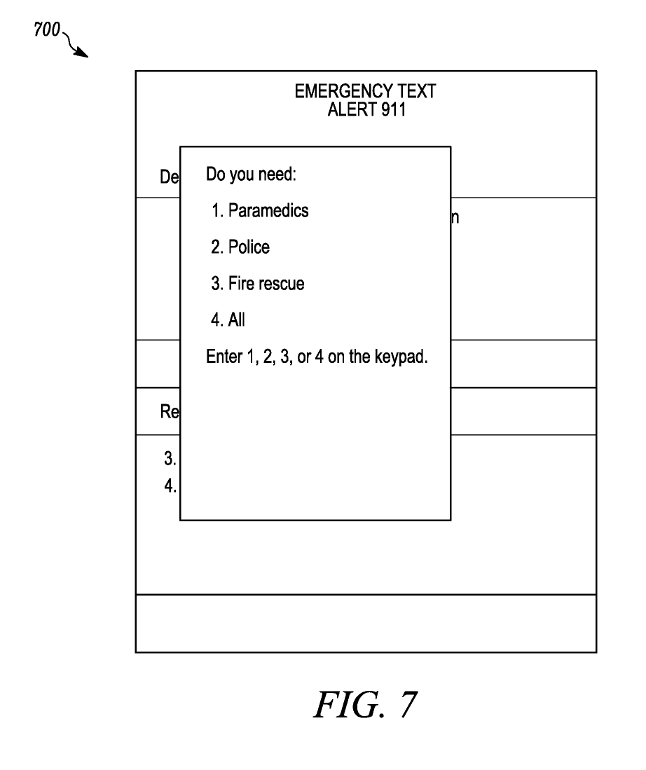

In blocks 222 and 224, which may be performed in parallel, RTT transmission mode communications between the communication device and the RTT destination is implemented. The communications may be bi-directional, and accordingly the communications includes the communication device receiving and displaying communications from the RTT destination on the display device (e.g., display device 138, FIG. 1) of the communication device, in block 222. In an embodiment, communications from the RTT destination are not transmitted using an RTT process or protocol, as mentioned previously. Instead, the communications from the RTT destination are transmitted using a standard texting protocol. In an alternate embodiment, communications from the RTT destination may be transmitted using an RTT process and protocol. The messages conveyed to the communication device may include, for example but not by way of limitation, an instruction to a user of the device; a question for the user; a statement intended for the user; a drop-down menu, a pop-up window, an option list, an image, a video clip, a video feed, and a map, among other things. For example, FIG. 6 illustrates an example of a display screen 600 produced on a display device of the communication device in response to receipt of a communication from an RTT destination, in accordance with an example embodiment. The display screen 600 includes first areas 602, 604 in which message from the RTT destination are presented (i.e., “Describe the emergency:” in area 602 and “3. Help is on the way” and “4. Is anyone hurt?” in area 604), and a second area 606 in which the user may enter text to be transmitted to the RTT destination (i.e., “Robbery gas sta main n auburn” in area 606). FIG. 7 illustrates an example of another display screen 700 produced on a display device of the communication device in response to receipt of a communication from an RTT destination, in accordance with an example embodiment. The display screen 700 includes a pop-up window 702 with the text “Do you need: 1. Paramedics 2. Police 3. Fire Rescue 4. All Enter 1, 2, 3, or 4 on the keypad.”

RTT transmission mode communications also involves the communication device transmitting indications of user inputs using an RTT process and protocol, in block 224. An embodiment of an RTT process is illustrated in FIG. 3, which is a flowchart of a method for a communication device to transmit user provided information while the communication device is in an RTT transmission mode. The method begins, in block 302, by determining whether a user input has been received via the user interface (e.g., user interface 130, FIG. 1). If not, the method iterates as shown, and the communication device continues to wait for a user input.

When a user input has been received (e.g., an entered character or editing input), an indication of the user input may be buffered, in block 304, or otherwise retained in a register, cache or memory location of the communication device. For example the indication of the user input may be a digital representation of a letter or number or command associated with a key actuation by the user. According to an embodiment, a user input includes manipulation of the user interface to select a single character or to provide an editing input.

A determination is made, in block 306 whether a transmit condition has been met. In an embodiment, the transmit condition is met when the user has manipulated the user interface to select a single character or to provide a single text editing input. In other embodiments, the transmit condition is met when the user has manipulated the user interface to select a set of characters comprising a word, a set of characters comprising a phrase, or a set of characters comprising a sentence. In yet another embodiment, the transmit condition may be met when the user has manipulated the user interface to select at least a single character or to provide at least a single text editing input and a predetermined time period has elapsed. In an embodiment, only a single transmit condition is valid in the system (e.g., selection of a single character). In other embodiments, multiple transmit conditions may be valid (e.g., selection of a single character and a “SEND” command received through the user interface).

When the transmit condition has not been met, then the method iterates as shown, and the communication device continues to wait for and buffer indications of user inputs. When the transmit condition has been met, then in block 308, the communication device transmits the indication(s) of the buffered user input(s) to the RTT destination over the communication network. According to an embodiment, the indication is transmitted using a ToIP (or TCP/IP) protocol. Transmitting the indication may include transmitting the indication using a data transmission technique that includes additional redundancy and/or reliability on top of that which already is implemented using the texting protocol (e.g., implementing an additional redundancy or reliability technique such as transmit diversity, implementing an ACK/NACK protocol, retransmitting the indication in response to an automatic repeat request, encoding the indication using a forward error correction technique with additional redundancy than would normally be employed for non-911 messaging, or another technique). In other words, while in RTT mode, the communication device transmits indications of user inputs using a data transmission technique that includes additional redundancy on top of that which would be implemented by the communication device using a non-RTT texting protocol (e.g., while the communication device is not in the RTT mode). After transmitting the indication(s) of buffered user input(s), the method then ends.

In an embodiment in which the transmit condition is the receipt (from the user interface) of a single user input (e.g., entry of a single character or editing input), the method of FIG. 3 may be simplified to include only blocks 302 and 308. More particularly, each time a user input is received (e.g., in block 302), an indication of the user input is transmitted (e.g., in block 308).

Referring again to FIG. 2, a determination is made, in block 226, whether the RTT session has been terminated. The RTT session may be terminated, for example, when the user provides an “END” indication, when the user fails to provide a response, within a default time period, to a previous message from the RTT destination, or when the communication device is powered down, for example. If the RTT session has not been terminated, the method continues to iterate as shown (i.e., by continuing to perform blocks 222, 224). If the RTT session has been terminated, then the method ends.

FIGS. 2 and 3 depict embodiments of methods for supporting RTT communications from the perspective of a communication device (e.g., communication device 120, FIG. 1). FIG. 4 depicts an embodiment of a method for supporting RTT communications from the perspective of a potential RTT destination (e.g., emergency response center 110, FIG. 1). More particularly, FIG. 4 is a flowchart of a method for a destination (e.g., an emergency response center) to execute an RTT session, in accordance with an example embodiment.

The method begins, in block 402, by establishing communications between the communication device and the potential RTT destination over a network (e.g., network 140, FIG. 1), in order to initiate a text session between the two devices. As discussed previously, establishing the text session may include, for example, the potential RTT destination receiving a session invitation message from the communication device, which indicates an identity of the communication device. The potential RTT destination may transmit an acknowledgement or other message back to the communication device, thus indicating that the potential RTT destination is available to support the text session. In an embodiment in which network communications is managed by a response system server (e.g., response system server 114, FIG. 1), establishing communications more specifically may include the response system server receiving and acknowledging the session invitation message.

A capabilities exchange process is then performed between the communication device and the potential RTT destination, in an embodiment, which includes the potential RTT destination transmitting information to the communication device indicating whether or not the potential RTT destination is RTT enabled. In an embodiment, this includes the response system server determining whether or not any response consoles (e.g., response consoles 116, FIG. 1) are available to support the text session, and if so whether any of the available response consoles are RTT enabled. If so, the response system server assigns an available, RTT enabled response console to support the text session, and transmits capabilities information to the communication device indicating that the potential RTT destination is RTT enabled. If no available response console is RTT enabled, the response system server assigns an available, non-RTT enabled response console to support the text session, and transmits capabilities information to the communication device indicating the potential RTT destination is not RTT enabled. If no response console at all is available, the response system server transmits a message to the communication device to that effect.

In addition, a text messaging application is initiated by the processing system (e.g., processing system 148, FIG. 1) of the available response console. The text messaging application is configured to support establishment of a text session, to transmit text messages over a communication network from the response console to the communication device (via the response system server 114 and network 140, FIG. 1), and to receive text messages received from the communication device, and to respond to those text messages (e.g., via a response component of the response system). According to an embodiment, a response component of the response system may be a display device (e.g., display device 152, FIG. 1), and responding to received text messages may include generating or controlling an image, displayed on a display device of the response system, in response to indications of user inputs conveyed in the text messages. In other embodiments, responding to received text messages may include other types of actions performed by other types of response components. For example, but not by way of limitation, a response component may include an audio system, in an embodiment, and responding to received text messages may include the audio system converting to speech indications of user inputs conveyed in the text messages. In an alternate embodiment, a response component may include an automated dispatch system, and responding to received text messages may include the automated dispatch system automatically initiating a dispatch-related response in response to the indications of user inputs conveyed in the text messages. In yet another embodiment, a response component may include an automated data logging system, and responding to received text messages may include the automated data logging system performing an automated data logging operation (e.g., storing the indications of user inputs in a cache or other data storage configuration so that the indications may be accessible at a later time). Although this description describes a display device displaying indications of user inputs in detail, it is to be understood that other types of responses performed by other types of response components falls within the scope of the embodiments.

Upon initiating a text application, the response console may display (e.g., on display device 152, FIG. 1) an initial screen having a first area in which text messages from the communication device may be displayed, and a second area in which responder-entered characters and responder-selected display elements may be displayed. Alternatively, text messages from the communication device and responder-entered characters and responder-selected display elements may be displayed in an interleaved manner in an area of the display screen. In addition, the screen may include other display elements. Upon provision of the initial display screen, the responder may type in characters and provide editing inputs through manipulation of the user interface (e.g., through manipulation of keyboard 150, FIG. 1).

When a determination is made, in block 404, that the destination is not RTT enabled, then in block 406, the potential RTT destination (or the assigned, non-RTT enabled response console 116, FIG. 1) remains in a normal operational mode, and text communications is carried out using a standard texting protocol, as described previously. More specifically, the process of automatically transitioning the potential RTT destination into RTT reception mode, which will be described in more detail below, is bypassed when the destination is not RTT enabled.

When a determination is made that the potential RTT destination is RTT enabled, then the RTT destination begins the transition into RTT reception mode, in block 408. In an embodiment, the text application instantiated on the response console includes a first algorithm for performing bi-directional communications using a standard texting protocol and a second algorithm for performing text message receipt using an RTT protocol and text message transmission using a standard texting protocol. In such an embodiment, the transition into the RTT reception mode includes branching execution of the text application to the second algorithm. In an alternate embodiment, the text application initiated on the response console may not be configured to support communications in the RTT reception mode, and instead the transition into the RTT reception mode includes invoking a separate texting application (e.g., an RTT application configured to performing text message receipt using an RTT protocol and text message transmission using a standard texting protocol) and stalling or terminating execution of the previously initiated text application.

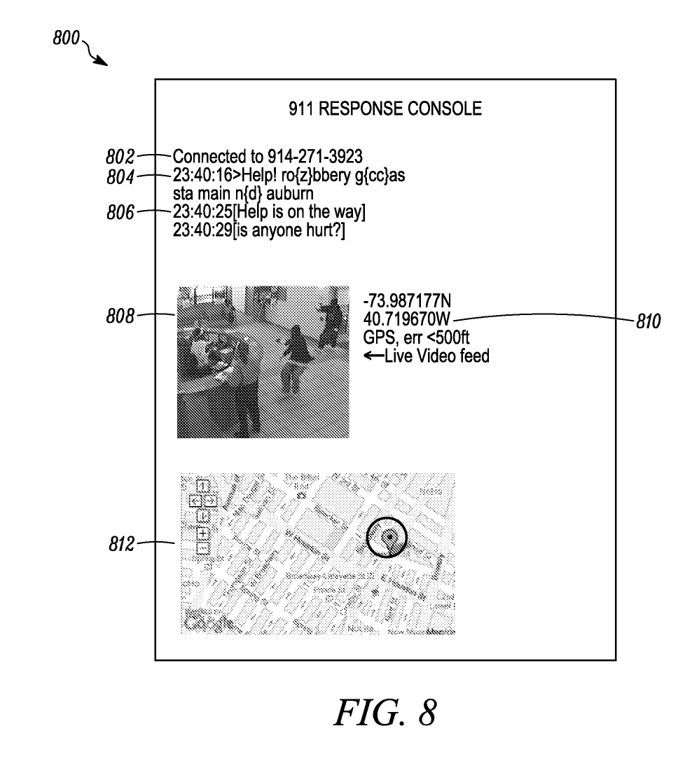

In block 410, the RTT destination receives previously buffered and transmitted characters from the communication device (e.g., characters buffered in block 204 and transmitted in block 220, FIG. 2), and the characters are displayed within the appropriate display area on the display device of the response console. In addition, the location information (e.g., as determined in block 213 and transmitted in block 220, FIG. 2) is received from the communication device. The processing system of the response console may cause the text and location information to be displayed (e.g., as GPS coordinates or an address), along with other information (e.g., the communication device's telephone number, images or video, a map display element, and other display elements), within various display areas of the display device of the response console, in an embodiment. For example, FIG. 8 illustrates an example of a display screen 800 produced on a display device (e.g., display device 152, FIG. 1) of a response console, in accordance with an example embodiment. The example display screen 800 includes a telephone number 802 associated with the communication device (i.e., “Connected to 914-271-3923”), previously buffered and RTT formatted messages 804 received from the communication device, along with the times of message reception (i.e., “23:40:16>Help! ro{z}bbery g {cc} as sta main n{d} auburn”), messages 806 transmitted by the RTT destination, along with the times of message transmission (i.e., “23:40:25[Help is on the way] 23:40:29[is anyone hurt?]”), a live video feed 808, location information 810, and a map element 812 corresponding to and pinpointing the location. As the example display screen 800 illustrates, control characters associated with editing inputs are displayed along with the text that the communication device user intended to type. For example, although the communication device user may have intended only to transmit “robbery gas sta main n auburn”, additional indications of deleted characters and editing inputs were transmitted using the RTT protocol, as well. The additional indications included, for example, a deleted character “z” in the word “robbery”, deleted characters “cc” in the word “gas”, and a deleted character “d” after the character “n.”

In blocks 412 and 414, which may be performed in parallel, RTT reception mode communications between the RTT destination and the communication device is implemented. The communications may be bi-directional, as discussed previously, and accordingly the communications includes the RTT destination generating and transmitting messages to the communication device (via response console 116 and response system server 114, FIG. 1), in block 412. In an embodiment, messages from the RTT destination are not transmitted using an RTT process or protocol, as mentioned previously. Instead, the communications from the RTT destination are transmitted using a standard texting protocol. In an alternate embodiment, communications from the RTT destination may be transmitted using an RTT process and protocol.

The messages transmitted by the RTT destination to the communication device may include, for example but not by way of limitation, an instruction to a user of the device; a question for the user; a statement intended for the user; a drop-down menu, a pop-up window, an option list, an image, a video clip, a video feed, and a map, among other things. Each of these types of messages may be generated based on inputs to the response console made by the human responder. For example, the responder may type text (e.g., a question or statement) using the keyboard (e.g., keyboard 150, FIG. 1) of the response console, and provide a “SEND” command, thus initiating generation and transmission of a text message that includes the text. Alternatively, the responder may select from a plurality of “canned” responses or queries that are accessible to and that may be displayed on the response console, and the selection may initiate generation and transmission of a text message that includes the canned response or query. In addition, in an embodiment, the responder may generate or select a pop-up window or drop-down menu (e.g., window or a menu that include options that may be selected by a user of the communication device, instructions to the user, or other information), and the generation or selection may initiate generation and transmission of a text message that includes the window or menu. The responder also may be able to select or generate other types of information for transmission to the communication device, including images, video clips, video feeds, maps, and so on.

RTT reception mode communications also involves the RTT destination receiving and responding to messages from the communication device, in block 414. For example, responding to the messages may include displaying information conveyed in the messages on a display device of a response console (e.g., display device 152, FIG. 1). According to an embodiment, reception and display of messages from the communication device is performed using an RTT protocol, as discussed previously. Because each message (e.g., each data packet) from the communication device may include less than an entire text message (e.g., each message may include an indication of only one character or editing input or only a few characters or editing inputs), implementation of the RTT protocol includes the response console displaying characters and editing inputs indicated in each message promptly upon receipt, where newly received characters and editing inputs are concatenated, on the display screen, with previously received and displayed characters and editing inputs. Accordingly, a cohesive message that indicates all of the communication device user's inputs may be displayed. According to an embodiment, a character processing function implemented by the response system server or the processing system of the response console manages the cohesive display of the received characters. As discussed previously, the response center may take other responsive actions in response to receiving messages from the communication device, in addition to or instead of displaying the indications of the user inputs on a display device. For example, as discussed previously, other responsive actions may include, but are not limited to, converting indications of user inputs to speech, automatically logging the indications, and/or performing an automated dispatch operation based on the indications of user inputs.

A determination is made, in block 416, whether the RTT session has been terminated. As mentioned previously, the RTT session may be terminated, for example, when the user of the communication device provides an “END” indication, when the user fails to provide a response, within a default time period, to a previous message from the RTT destination, or when the communication device is powered down, for example. An RTT session also may be terminated by the human responder (e.g., when the human responder provides an “END” indication). If the RTT session has not been terminated, the method continues to iterate as shown (i.e., by continuing to perform blocks 412, 414). If the RTT session has been terminated, then the method ends.

As discussed previously, a particular embodiment involves RTT communications between a communication device and an emergency response center as a destination. FIGS. 5-8, discussed previously, illustrate an example of a series of communication device and emergency response center display screens, in accordance with an example embodiment. The illustrated examples are not to be construed as limiting application of the various embodiments to RTT communications between a communication device and an emergency response center. Instead, it is to be understood that RTT communications may be performed between a communication device and any other type of RTT enabled destination, in other embodiments.

As the illustrated and described examples indicate, more comprehensive information regarding actual user inputs are transmitted to and displayed at a response console than the user may have intentionally and affirmatively sent (e.g., by inputting a “SEND” command). This may enable a responder at an emergency response center to gain a more comprehensive understanding of the situation at hand, and to provide or dispatch assistance more readily. In addition, transmission of characters from the communication device to an emergency response center using the methods described herein enables partially complete messages to be sent to and received by an emergency response center even if the communication device user never inputs a “SEND” command. For example, a user in distress may begin inputting a message such as “I am not feeling we”, and may lose consciousness or otherwise be unable to complete the message. In such a situation, the partial message may be transmitted to the emergency response center even if a “SEND” command is never entered by the user, and the responder may glean enough information from the partial message to provide or dispatch assistance.

The foregoing detailed description is merely exemplary in nature and is not intended to limit the invention or the application and uses of the invention. Furthermore, there is no intention to be bound by any expressed or implied theory presented in the preceding technical field, background, brief summary or detailed description.

For simplicity and clarity of illustration, the drawing figures illustrate the general manner of construction, and descriptions and details of well-known features and techniques may be omitted to avoid unnecessarily obscuring the invention. Additionally, elements in the drawings figures are not necessarily drawn to scale. For example, the dimensions of some of the elements or regions in some of the figures may be exaggerated relative to other elements or regions of the same or other figures to help improve understanding of embodiments of the invention.

The terms “first,” “second,” “third,” “fourth” and the like in the description and the claims, if any, may be used for distinguishing between similar elements and not necessarily for describing a particular sequential or chronological order. It is to be understood that the terms so used are interchangeable under appropriate circumstances such that the embodiments of the invention described herein are, for example, capable of operation or use in sequences other than those illustrated or otherwise described herein. Furthermore, the terms “comprise,” “include,” “have” and any variations thereof, are intended to cover non-exclusive inclusions, such that a process, method, article, or apparatus that comprises a list of elements is not necessarily limited to those elements, but may include other elements not expressly listed or inherent to such process, method, article, or apparatus. It is to be understood that the embodiments of the invention described herein may be used, for example, in other orientations than those illustrated or otherwise described herein. The term “coupled,” as used herein, is defined as directly or indirectly connected in an electrical or non-electrical manner.

A first embodiment includes a method performed by a communication device. The method comprises the steps of detecting that a text session has been initiated by the communication device with a potential RTT destination specified as a destination for text messages transmitted by the communication device, and in response to the detecting step, automatically transitioning the communication device into an RTT transmission mode.

Another embodiment includes a method performed by a communication device, which comprises the steps of initiating a text application configured to transmit a text message over a communication network from the communication device to a destination specified by a user of the communication device, and determining whether the destination is a potential RTT destination. When the destination is not a potential RTT destination, the text message is communicated using a standard texting protocol, and when the destination is a potential RTT destination, the text message is communicated using an RTT protocol.

Yet another embodiment includes a communication device comprising a user interface, and a processing system. The user interface is configured to detect a user input. The processing system, which is operably coupled to the user interface, is configured to detect that a text session has been initiated by the communication device with a potential RTT destination specified as a destination for text messages transmitted by the communication device, and in response to the detecting step, automatically to transition the communication device into an RTT transmission mode.

Yet another embodiment includes a method performed by a response system that is communicatively coupled with a communication network. The method comprises the steps of establishing communications with a communication device over the communication network, transmitting information to the communication device that indicates that the response system is RTT enabled, and receiving at least one message from the communication device that was transmitted according to an RTT protocol. The at least one message includes at least one indication of a user input made by a user of the communication device. The method also includes responding to the at least one indication of the user input.

Yet another embodiment includes a method performed in a system that includes a communication network, a response system that is communicatively coupled with the communication network, and a communication device that is communicatively coupled with the communication network. The method comprises the steps of detecting, by the communication device, that a text session has been initiated with a potential RTT destination specified as a destination for text messages transmitted by the communication device, and performing a capabilities exchange process over the communication network between the communication device and the response system to determine whether the response system is RTT enabled. When the response system is RTT enabled, the method further includes receiving, by the response system, at least one message from the communication device that the communication device transmitted according to an RTT protocol, where the at least one message includes at least one indication of a user input made by a user of the communication device, and responding, by the response system, to the at least one indication of the user input.

Yet another embodiment includes a response system communicatively coupled to a communication network. The response system comprises at least one response console comprising a processing system and a response component. The processing system is configured to receive at least one message over the communication network from a communication device, where the at least one message was transmitted according to an RTT protocol, and the at least one message includes at least one indication of a user input made by a user of the communication device. The response component, which is coupled to the processing system, is configured to respond to the at least one indication of the user input.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method performed by a response system that is communicatively coupled with a communication network, the method comprising the steps of:
establishing communications with a communication device over the communication network;
transmitting information to the communication device that indicates that the response system is real time text (RTT) enabled;
receiving at least one message from the communication device that was transmitted according to an RTT protocol, wherein the at least one message includes at least one indication of a user input made by a user of the communication device; and
responding, by the response system, to the at least one indication of the user input.

2. The method of claim 1, wherein establishing communications comprises:
receiving a session invitation message from the communication device; and
acknowledging the session invitation message.

3. The method of claim 1, wherein the response system comprises a server communicatively coupled with a response console, and the method further comprises the steps of:
determining, by the server, whether the response console is available to support the communications; and
when the response console is available, assigning the response console to support the communications.

4. The method of claim 1, wherein responding comprises displaying the at least one indication of the user input on a display device of the response system.

5. The method of claim 4, wherein the step of receiving the at least one message from the communication device comprises receiving multiple messages from the communication device, and wherein the step of displaying comprises:
concatenating, on the display device, an indication of at least one user input from a newly received message with a displayed indication of at least one user input from a previously received message, wherein each of the indication and the displayed indication includes an indication selected from a group consisting of: an indication of a character; and an indication of an editing input.

6. The method of claim 5, wherein the indication of an editing input is selected from a group consisting of: an indication of a backspace selection; an indication of a deletion of one or more characters; and an indication of a character selection.

7. The method of claim 4, further comprising:
receiving, from the communication device, location information that indicates a location of the communication device; and
displaying the location information on the display device.

8. The method of claim 1, wherein the response console includes a user interface, and the method further comprises:
receiving at least one responder-entered input through the user interface; and
transmitting a message that includes an indication of the responder-entered input to the communication device over the communication network.

9. The method of claim 8, wherein transmitting the message is performed according to a standard texting protocol selected from a group consisting of a Multimedia Messaging Service (MMS) protocol, a Short Message Service (SMS) protocol, or a Session Initiation Protocol for Instant Messaging and Presence Leveraging Extensions (SIMPLE) protocol.

10. The method of claim 8, wherein the message includes information selected from a group consisting of: an instruction; a question; a statement; a drop-down menu; a pop-up window; an option list; an image; a video clip; a video feed; and a map.

11. The method of claim 1, wherein responding to the at least one indication comprises generating or controlling an image, displayed on a display device, in response to the at least one indication.

12. The method of claim 1, wherein responding to the at least one indication comprises converting to speech the at least one indication.

13. The method of claim 1, wherein responding to the at least one indication comprises performing an automated dispatch operation responsive to the at least one indication.

14. The method of claim 1, wherein responding to the at least one indication comprises performing an automated data logging operation responsive to the at least one indication.

15. A method performed in a system that includes a communication network, a response system that is communicatively coupled with the communication network, and a communication device that is communicatively coupled with the communication network, the method comprising the steps of:
detecting, by the communication device, that a text session has been initiated with a potential real time text (RTT) destination specified as a destination for text messages transmitted by the communication device;
performing a capabilities exchange process over the communication network between the communication device and the response system to determine whether the response system is RTT enabled;
when the response system is RTT enabled, receiving, by the response system, at least one message from the communication device that the communication device transmitted according to an RTT protocol, wherein the at least one message includes at least one indication of a user input made by a user of the communication device; and
responding, by the response system, to the at least one indication of the user input.

16. The method of claim 15, wherein the response system includes a user interface, and the method further comprises:
receiving at least one responder-entered input through the user interface; and
transmitting a message that includes an indication of the responder-entered input to the communication device over the communication network.

17. The method of claim 16, wherein transmitting the message is performed according to a standard texting protocol.

18. The method of claim 15, wherein the response system comprises a server communicatively coupled with a response console, and the method further comprises the steps of:
determining, by the server, whether the response console is available to support the communications; and
when the response console is available, assigning the response console to support the communications.

19. The method of claim 15, wherein responding to the at least one indication comprises displaying the at least one indication on a display device of the response system.

20. The method of claim 19, wherein the step of receiving the at least one message from the communication device comprises receiving multiple messages from the communication device, wherein each of the multiple messages includes an indication of at least one user input provided by a user of the communication device, and wherein the step of responding comprises:
concatenating, on the display device, an indication of at least one user input from a newly received message with a previously received and displayed indication of at least one user input.

21. The method of claim 15, wherein responding to the at least one indication comprises generating or controlling an image, displayed on a display device, in response to the at least one indication.

22. The method of claim 15, wherein responding to the at least one indication comprises converting to speech the at least one indication.

23. The method of claim 15, wherein responding to the at least one indication comprises performing an automated dispatch operation responsive to the at least one indication.

24. A response system communicatively coupled to a communication network, the response system comprising:
at least one response console comprising
a processing system configured to receive at least one message over the communication network from a communication device, wherein the at least one message was transmitted according to a real time text (RTT) protocol, and the at least one message includes at least one indication of a user input made by a user of the communication device; and
a response component, coupled to the processing system, and configured to respond to the at least one indication of the user input.

25. The response system of claim 24, wherein the at least one response console further comprises:
a user interface, coupled to the processing system, and configured to enable a human responder to provide at least one responder-entered input, and
wherein the response system is further configured to transmit a message that includes an indication of the responder-entered input to the communication device over the communication network.

26. The response system of claim 24, further comprising:
a server, communicatively coupled with the at least one response console, and configured to communicate information originating from the at least one response console to the communication device via the communication network, and to communicate information received from the communication device via the communication network to the at least one response console.

27. The response system of claim 26, wherein the at least one response console comprises multiple response consoles, and wherein the server is further configured to determine that a particular response console of the at least one response console is available to support RTT communications received from the communication device in a context of an RTT session, and to assign the particular response console to support the RTT communications.

28. The response system of claim 24, wherein the response system is a call center responsible for answering calls from and supporting text communication sessions with network-connected communication devices.

29. The response system of claim 24, wherein the response component is a display configured generate or control an image in response to the at least one indication of the user input.

30. The response system of claim 24, wherein the response component is an audio system configured to convert to speech the at least one indication of the user input.

31. The response system of claim 24, wherein the response component is an automated dispatch system responsive to the at least one indication.

32. The response system of claim 24, wherein the response system is a Public Safety Answering Point.
